(19) United States
(12) Patent Application Publication
(10) Pub. No.: US 2008/0248707 A1
(43) Pub. Date: Oct. 9, 2008

(54) Armor material and method for producing it

(75) Inventors: Rainer Liebald, Nauheim (DE); Wolfram Beier, Essenheim (DE); Jochen Alkemper, Klein-Winternheim (DE); Ulrich Schiffner, Mainz (DE)

Correspondence Address: DeMont & Breyer, LLC, 100 Commons Way, Ste. 250, Holmdel, NJ, 07733, US

(73) Assignee: SCHOTT AG, Mainz (DE)

(21) Appl. No.: 11/940,306

(22) Filed: Nov. 14, 2007

(30) Foreign Application Priority Data
Nov. 29, 2006 (DE) 10 2006 056 209.7

(51) Int. Cl. C04B 35/195; B32B 17/12; C04B 35/18; C03B 19/00

(52) U.S. Cl. 442/181; 501/2; 501/8; 501/9; 442/304; 442/327; 65/17.6

(57) ABSTRACT

The invention is based on the object of providing armoring that is lightweight and exhibits a denser microstructure that is improved as against ceramic composite materials. To this end, armoring against high dynamic impulsive loads is provided that comprises a composite material having at least two phases, the first phase forming a matrix for the second phase, and the first phase being a glass or a glass ceramic, and the second phase being embedded and distributed in the form of particles and/or fibers in the matrix formed by the material of the first phase.

The invention relates in general to armorings, in particular armorings against high dynamic impulsive loads based on glass materials or glass-ceramic materials.

Armorings are generally built up as a laminar structure having a hard material and a substrate or backing. Amide fiber fabrics, steel nettings or else steel plates, for example, come into use as substrate. Such armorings are used, for example, for personal protection, for example for a bulletproof vest or for protection of objects such as vehicles and flying apparatuses. It is important in all these fields of use that the armorings do not become excessively heavy being of high strength.

U.S. Pat. No. 4,473,653 A discloses armoring having a lithium-aluminosilicate glass ceramic, and its production. It is also known to protect flying apparatuses such as, for example, helicopters by means of borocarbide-containing armorings. In general, use is made for this purpose of a ceramic that contains aluminum oxide (Al₂O₃), silicon carbide (SiC), borocarbide (B₄C) and titanium boride (TiB₂). These materials are relatively light, but are also very expensive owing to the complicated production. Armorings made from ceramic composite material are also disclosed in U.S. Pat. No. 5,763,813 A.

In the case of the multiply used ceramic materials for antiballistic armorings, for example armorings against high dynamic impulsive loads such as upon the striking of projectiles, there is the general problem that ceramic still has a certain porosity. The pores can in this case constitute weak points that favor the propagation of cracks upon the striking of a projectile. Particularly in the case of ceramic composite materials, the problem also arises, furthermore, that the ceramic matrix frequently does not perfectly enclose the further phase such as, for example, embedded fibers, since the ceramic material cannot flow upon sintering. Increased porosities can therefore occur precisely with ceramic materials. In addition, many ceramic materials suitable for armorings exhibit high weight. Thus, the density of aluminum oxide ceramic is approximately 4 g/cm³.

It is therefore the object of the invention to provide armoring against high dynamic impulsive loads, for example against bombardment, that is lightweight and exhibits a denser microstructure that is improved as against ceramic composite materials. This object is already defined in a surprisingly simple way by the subject matter of the independent claims. Advantageous refinements and developments of the invention are specified in the respective dependent claims.

The invention consequently provides a preferably plate-shaped armoring or armor against high dynamic impulsive loads that comprises a composite material having at least two phases, the first phase forming a matrix for the second phase, and the first phase being a glass or a glass ceramic, and the second phase being embedded and distributed in the form of particles and/or fibers in the matrix formed by the material of the first phase. Such armoring is produced by mixing fibers and/or particles with pulverulent material that forms glass or glass ceramic, and the mixture is heated such that there is formed from the material that forms glass or glass ceramic a flowable glass or glass-ceramic phase that fills in interspaces between the fibers and/or particles such that after being cooled the fibers and/or particles are embedded and distributed in the solidified glass or glass-ceramic phase.

By contrast with conventional ceramic armorings, this offers the advantage that interspaces between the fibers and/or particles of the at least one further phase of the composite can be substantially more effectively filled in, owing to the flowability of the material forming glass or glass ceramic, than in the case of sintering a ceramic. The inventive process can also be denoted as liquid-phase sintering, since the glass or glass ceramic is at least semifluid during its crystallization. Consequently, dense filling is effected with a low fraction of pores between the fibers and/or particles of the second phase. It is possible in this case to achieve a density of the composite material of above 99% of the theoretical density of a nonporous body with the components used. A substantial advantage of the invention is, furthermore, that with the glass or glass-ceramic composites described the density of the material can nevertheless be kept to below 3.5 g/cm³, even when use is made of steel particles or steel fibers in the glass or glass-ceramic matrix. If particles or fibers other than steel fibers, for example steel particles, are used, the density of the material can be reduced even substantially further. Consequently, the material is superior to many ceramic armorings in view of its low weight.

A better connection of the two phases, that is to say between the fibers/particles and the glass or glass-ceramic matrix, is achieved, in particular, by the denser microstructure. A high fracture toughness against high dynamic mechanical loads such as occurs upon being struck by a projectile is thereby achieved. The common feature of all the developments of the invention described below is, inter alia, that the armor material is built up additively from its individual components.

In order to produce the inventive multiphase armorings, the components are mixed and the mixture is subjected to heat treatment. Specifically, there are many different ways of producing multiphase materials containing glass or glass ceramic. One preferred possibility is to produce the armoring by hot isostatic pressing of the mixture. The pressure exerted on the mixture during hot isostatic pressing assists the flow of the vitreous material. In a development of this embodiment of the invention, a portion of the mixture can be subjected to a dry pressing process. The pressed shaped body can then be finished by hot isostatic pressing in a further fabrication step. Alternatively, it is also possible to produce as preliminary product a preliminary body of the mixture, or a prepreg, and for the preliminary body subsequently to be uniaxially hot pressed.

In each case, a preliminary body can firstly be produced from the mixture by cold isostatic pressing and subsequently be sintered by heating, for example, in a hot isostatic fashion or under uniaxial hot pressing, or else without pressure. In the case of cold isostatic pressing, pressures of at least 500 atmospheres, preferably at least 200 atmospheres, are preferably exerted in the press on the mixture, in order to obtain as dense a microstructure as possible even before the sintering.

As further phases of the composite that are mixed with the material forming glass or glass ceramic in order to produce the armoring, particular consideration is given to the following materials:

carbon fibers, hard fibers, such as fibers made from SiC (silicon carbide), Si₃N₄ (silicon nitride), Al₂O₃ (aluminum oxide), ZrO₂ (zirconium oxide), boron nitride, and/or mullite as main components, appropriately with admixtures of Si, Ti, Zr, Al, O, C, N, for example fibers of the sialon type (Si, Al, O, N), glass fibers, metal fibers, such as, in particular, steel fibers, metal particles, hard particles, such as, in particular, particles made from the above-named materials of hard fibers. The above-named materials can also be combined with one another with particular advantage.

Carbon fibers and silicon carbide fibers or particles have comparatively low coefficients of thermal expansion. In order to reduce internal stresses in the material between the fibers and/or particles and the surrounding matrix, it is particularly in the case of such materials of the second phase that it is favorable to use a glass or glass-ceramic matrix with a low linear coefficient of thermal expansion, preferably less than 10*10⁻⁶/K.

The goal and core of the invention is to set the multiphase nature suitably so as to attain a high fracture toughness and thus, finally, a resistance to bombardment, and/or a high resistance to high dynamic mechanical loads. If metal particles and/or metal fibers are embedded, this is achieved by alternating ductile and brittle components. In the case of fiber-reinforced glasses and glass ceramics, the high fracture toughness against high dynamic loads is achieved by a pull-out effect that absorbs energy strongly. Relevant elementary mechanisms in the composite are, for example, crack deflection, crack branching, crack stoppage and energy dissipation. Additionally, because of the different speeds of sound in the individual materials of the composite material, scattering and dispersion of the shockwave produced during striking occur, and so the shockwave is weakened.

Particularly suitable as particles are metal chips, preferably with dimensions of up to a length of 1 cm. These metal chips can absorb large quantities of kinetic energy by deformation. In the case of fibers as component of the second phase, smaller dimensions are preferred instead of wires. In particular, fibers with diameters of less than 0.2 millimeters can be used. The thin fibers can thus be admixed in a larger number. This is advantageous in order to effect a distribution of the forces in a large number of different directions.

The fibers can be short, long and endless fibers. The fibers can be embedded in ordered or unordered fashion. There are, in turn, various possibilities for ordered fiber arrangements with nonmetallic fibers such as, for example, woven, knitted or nonwoven fabrics. For example, it is possible to use crossply fabrics (0°/90° fabrics) or fabrics with fiber angles of 0°/45°/90°/135°.

Glass ceramics are generally distinguished by high base values of the elasticity module, and are therefore very well suited to armoring against high dynamic impulsive loads. However, it emerges that glass ceramics in crystallized form generally can be sintered only with difficulty, or even no longer, in particular when use is made of the inventive liquid phase sintering process, in the case of which the material forming glass ceramic is intended to be liquid at least for a time.

However, this can be solved in a development of the invention by virtue of the fact that powder of a starting glass for glass ceramic is used as material forming glass ceramic, and a ceramizing of the starting glass takes place during the heating of the mixture. Consequently, in this case the starting glass, which is also denoted as green glass, is firstly formed as the mixture is heated. This green glass can then flow into the interstices between the particles and/or fibers of the second phase before complete ceramization takes place. As the composite material is being produced, the temperature is preferably controlled such that at least partial ceramization of the green glass takes place during heating of the mixture, for example under isostatic or uniaxial pressing.

In the case of glass ceramics as matrix, there is also the idea, in particular, of using glass ceramics other than MAS glass ceramics (magnesium-aluminum-silicate glass ceramics). CaO—Al₂O₃—SiO₂ glass ceramics or MgO—CaO—BaO—Al₂O₃—SiO₂ glass ceramics are material systems suitable for the glass-ceramic matrix as against the above-named MgO—Al₂O₃—SiO₂ glass ceramics (MAS glass ceramics).

A further glass-ceramic class particularly suitable for the invention is represented by Mg—Al-containing glass ceramics which include a spinel phase, preferably MgAl₂O₄-based spinels. These crystallites are distinguished by a high modulus of elasticity. Because of the crystallites with spinel structure, these glass ceramics surprisingly prove to be particularly stable against high dynamic impulsive loads in conjunction with the incorporated particles and/or fibers.

Glass ceramics such as, for example, cordierite glass ceramics that can be processed to form a very hard composite material with the admixture of hard particles. Zirconium oxide-containing particles are particularly suitable for this glass ceramic. Fibers and/or ductile components such as metal particles are particularly suitable here for the purpose of improving the fracture toughness of the admittedly hard, but also brittle material.

The maximum process temperature when heating the mixture to produce the armor material is preferably selected with the aid of the processing temperature or another suitable characteristic of the temperature-dependent profile of the viscosity of the glass used. This ensures that the glass melt can flow sufficiently well into the interstice between the other components, in particular the particles and/or fibers of the further phase. Here, 800° C. can already suffice as processing temperature for so-called low-Tg glasses (glasses with a low transformation temperature of less than 560° C.). Processing temperatures above 1200° C. are preferred for many other technical glasses. It is preferred to use as processing temperature a temperature in the case of which the viscosity is less than or equal to the Littleton point of ρ=10^{7.6} dPas·s.

Alternatively or in addition to using glass powder for producing the mixture with the fibers and/or particles, it is also possible to use a mixture of the starting materials for a glass or a glass ceramic as material forming glass or glass ceramic, and to mix it with the fibers and/or grains. In this case, the glass is then produced upon heating the mixture to the temperature required for producing the glass. Boron acid-containing glasses such as, in particular, borosilicate glasses, are particularly suitable glasses for producing the inventive armoring, or the matrix thereof, for the incorporated fibers and/or particles. The high thermal shock resistance of borosilicate glass also turns out to be advantageous for resistance to high dynamic loads such as occur upon striking by a projectile. Borosilicate glass powder can be used as glass-forming material in order to produce such armoring. Alternatively or in addition, it is also possible to mix the starting materials for borosilicate glass with the fibers and/or particles such that the borosilicate glass forms from the starting materials upon heating of the mixture. Preferred ranges of composition of such glasses in percent by weight on an oxide basis are 70-80% by weight of SiO₂, 7-13% by weight of B₂O₃, 4-8% by weight of alkalioxides and 2-7% by weight of Al₂O₃. These glasses, which also include the glasses known under the trade names of “Pyrex” and “Duran”, have a linear coefficient of thermal expansion in the range of 3-5*10 ⁻⁶/K and a glass transition temperature in the range of 500° C. to 600° C.

It is also possible to use aluminosilicate glasses as matrix. Glasses are preferred here which exhibit the following composition in percent by weight on an oxide basis: 50-55% by weight of SiO₂, 8-12% by weight of B₂O₃, 10-20% by weight of alkaline-earth oxides, and 20-25% by weight of Al₂O₃.

Furthermore, thought is also being given to the use of alkaline alkaline-earth silicate glass for the glass matrix of the first phase of the armoring. Preferred compositions lie in the range of 74±5% by weight of SiO₂, 16±5% by weight of Na₂O, 10±5% by weight of CaO. These glasses are particularly favorable in price and, inter alia, also permit the economic production of large area armorings. Again, the linear coefficient of thermal expansion is generally still lower than 10*10⁻⁶/K.

Furthermore, it is also possible to use basalt glass or a starting glass for rock wool.

If the projectile strikes the armoring, its kinetic energy is dissipated as it penetrates into the armor material. The effect of the armoring can therefore be improved by having its microstructure change in a direction along the direction from which the projectile strikes, that is to say generally in a direction perpendicular to the exposed side of the armoring. In particular, it is also advantageously possible for the density, composition or size of the fibers and/or particles to change along this direction. In this case, it is a varying particle and/or fiber density that is understood by a varying density. Thus, the armoring can be of plate-shaped design, the fibers or particles being arranged with density varying perpendicular to a lateral surface of the plate-shaped armoring.

A preferred volume fraction of the second phase, that is to say the volume fraction of the fibers and/or particles incorporated in the matrix, is in the range from 10 to 70% by volume.

An inventive armoring against high dynamic impulsive loads is particularly suitable for use in a personal protection device, in particular for armored garments such as armored vests, and for armoring of vehicles and flying apparatuses. A desire for low weight is common to these applications. In particular, the lightweight, but very expensive boron carbide-containing ceramic armorings can be replaced by the invention.

Furthermore, it is also possible for a number of different inventive composite materials having a glass or glass-ceramic matrix and preferably fibers and/or particles distributed in both materials to be arranged on one another in order to produce a particularly effective composite. For example, two inventive plate-shaped composite materials can be placed on one another. This can be done directly or with the aid of an intermediate material.

Virtually any desired shapes of the composite material can be produced by means of the inventive production method by means of liquid phase sintering of a mixture having a material, forming glass or glass ceramic, and fibers and/or particles.

A particular synergy effect can be produced if use is made of metal fibers and/or particles as component of the second phase. Because of their ductility, metal components not only act strongly to absorb energy, but can accelerate the production method. In this case, specifically, the mixture with the pulverulent material, which forms a glass or glass-ceramic matrix, can be heated inductively, the metal fibers and/or particles being heated by the electromagnetic field of the induction heating, and outputting the heat to the surrounding material. Since the energy is in this way input directly into the volume of the mixture, the heating can be carried out very quickly and, moreover, very homogeneously.

The invention is explained in more detail below with the aid of exemplary embodiments and with reference to the attached drawings, in which the same reference numerals refer to the same or similar parts, and in which:

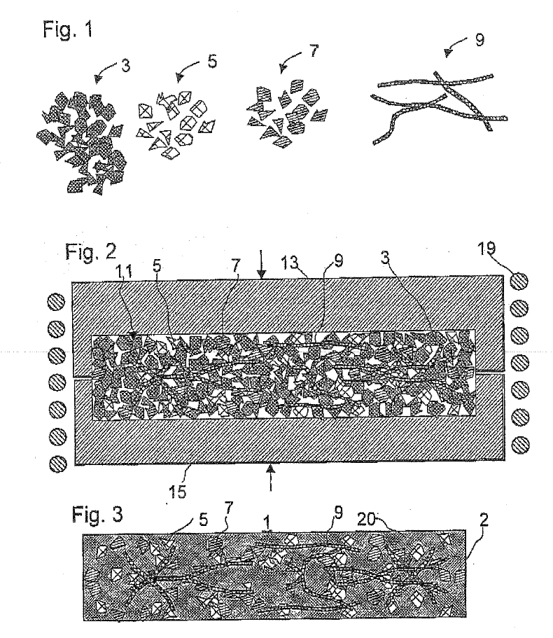

FIG. 1 to FIG. 3 show production steps for a composite material of armoring,

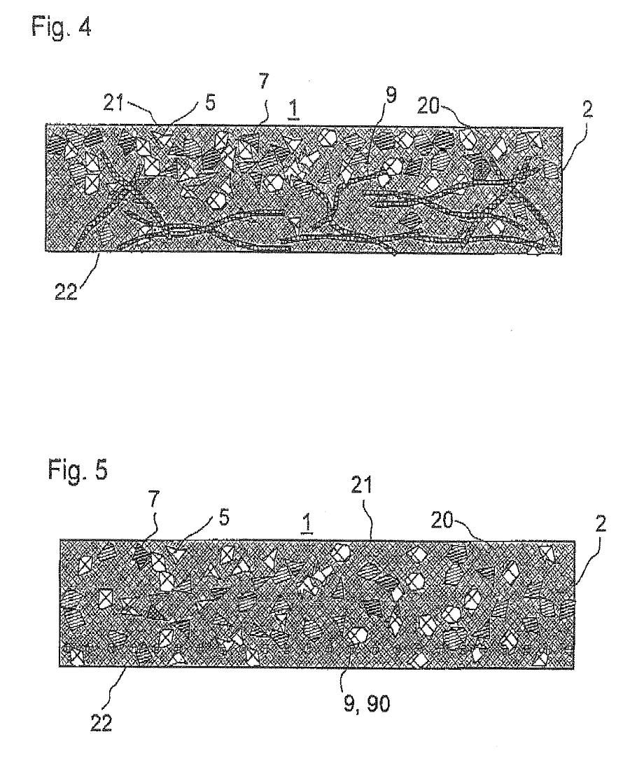

FIG. 4 shows armoring with a varying distribution of the composite material,

FIG. 5 shows a composite material enforced with a fabric,

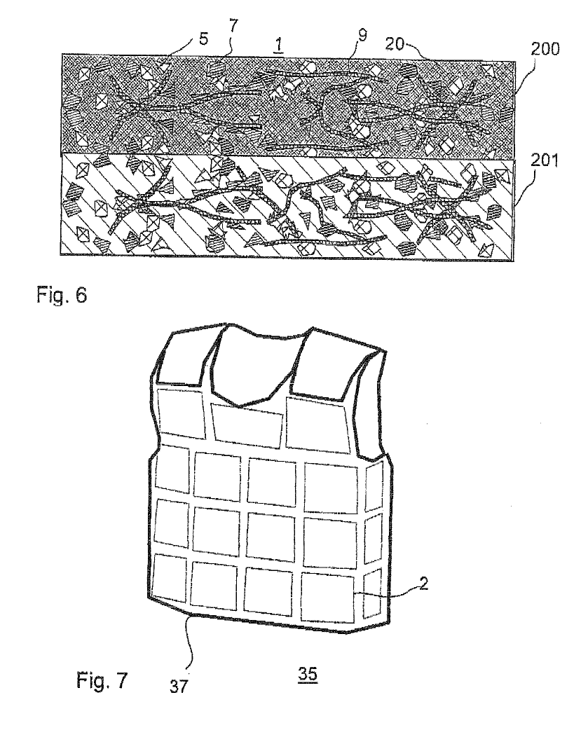

FIG. 6 shows a composite having two composite materials, and

FIG. 7 shows an example of armoring against high dynamic impulsive loads in the form of a bulletproof vest.

FIGS. 1 to 3 show production steps for armoring against high dynamic impulsive loads with the aid of a composite material which contains at least two phases, the first phase forming a matrix for the second phase, and the first phase being a glass or a glass ceramic, and the second phase being embedded and distributed in the form of particles and/or fibers in the matrix formed by the material of the first phase. As is illustrated schematically with the aid of FIGS. 1 to 3, the production is based on the fact that fibers and/or particles are mixed with pulverulent material that forms glass or glass ceramic, and the mixture is heated such that there is formed from the material that forms glass or glass ceramic a flowable glass or glass-ceramic phase that fills in interspaces between the fibers and/or particles such that after being cooled the fibers and/or particles are embedded and distributed in the solidified glass or glass-ceramic phase.

As shown in FIG. 1, the components used for the mixture are firstly provided. In the case of the example shown, these are glass powder with glass particles 3, hard particles 5, metal particles 7 and fibers 9. Pulverized borosilicate glass, for example, can be used as glass powder. Likewise, a pulverized green glass for a glass ceramic, for example, a cordierite glass ceramic, or a high-quartz solid solution, or glass ceramic forming crystallites with spinel structure can be used. The hard particles 8 and fibers 9 can respectively contain SiC, Si₃N₄, Al₂O₃, ZrO₂, boron nitride, and/or mullite as main components. Alternatively or in addition to hard fibers, it is also possible to use metal fibers such as, in particular, steel fibers and/or carbon fibers. The fibers are preferably thin with diameters of at most 0.2 millimeters. Furthermore, the metal particles 7 can be present in the form of chips, preferably with dimensions of up to a length of 1 cm.

As illustrated in FIG. 2, the components illustrated in FIG. 1 are subsequently mixed and pressed in a press between two compression mold halves 13, 15 in a cold isostatic fashion to form a preliminary body 11. This shaped body 11 is subsequently heated beyond the softening temperature T_{g} of the glass such that the glass becomes flowable and fills in the remaining gaps between the particles 5, 7 and fibers 9. If a starting glass or green glass of a glass ceramic is used, the heating is preferably carried out such that ceramizing of the glass also occurs.

The admixture of the metal particles 7 in this case enables heating to be done inductively by means of an induction coil 19 surrounding the compression mold. The electromagnetic alternating field heats the metal particles 7 directly by currents induced in the particles. The metal particles output their heat to the surrounding material such that a quick temperature compensation and homogeneous heating are achieved. Irrespective of the compression method, it is generally preferred to make use for the inductive heating of high or medium frequency currents to excite the induction coil 19 with frequencies in the range of 5 to 500 kHz.

The resulting plate-shaped composite material 2 of armoring 1 is illustrated in FIG. 3. Flowing of the glass produces a glass or glass-ceramic matrix 20 in which the particles 5, 7, 9 are embedded and distributed.

The glass or glass-ceramic matrix 20 is very hard, but also brittle. The hardness of the material is further raised locally by the incorporated hard particles. These particles have a destructive effect on a striking projectile. In addition, because of their ductility, the metal particles 7 act to absorb energy and distribute the forces transferred from the projectile onto the material. Finally, the fibers 9 raise the fracture toughness with reference to the high dynamic impact loads upon the striking of the projectile.

A variant of the example shown in FIG. 3 is illustrated in FIG. 4. In the case of this variant, the particles 5, 7 and fibers 9 are not, as with the example shown in FIG. 3, distributed homogeneously over the volume of the plate-shaped composite material of the armoring 1 with sides 21, 22.

Rather, the fibers 9 and/or particles 5, 7 exhibit a density varying in a direction perpendicular to an exposed side of the armoring. The exposed side, that is to say the surface which points outward in the case of the armoring and on which a projectile then strikes in the case of a bombardment, can, for example, be the side 21 in the case of the armoring 1 shown in FIG. 4. As is to be seen with the aid of FIG. 4, the density of the particles 5, 7 increases moving from side 21 to side 22, while the density of the fibers 9 increases along this direction such that the highest concentration of fibers is present in the region of the side 22, that is to say the rear side, for example. If a projectile strikes the side 21, the hard particles 5 in the hard glass or glass-ceramic matrix 20 act to destroy the projectile, while the ductile metal particles 7 act to absorb energy by deformation.

In addition, owing to the different density of the matrix 20 and the particles 5, 7, the ensuing shockwave is dispersed at the particles such that the shockwave strikes the rear side 22 with reduced intensity. The fibers 9, which are embedded on the rear side with a higher particle density, raise the fracture toughness there and enable the ensuing tensile loads along the rear side to be absorbed. This prevents the composite material from tearing into pieces, something which would lead to passage of the projectile.

Yet another development is illustrated in FIG. 5, where the fibers 9 are embedded in the matrix of the composite material 2 in a form of a hard fiber fabric 90. To this end, the compression mold for producing the starting body or the composite material can be filled partially with the pulverized material 3 forming glass or glass ceramic, the fabric 90 can be inserted, and the compression mold can then be filled further with material 3 forming glass or glass ceramic. Hard particles 5 and/or metal particles 7 can, in turn, be admixed to the material 3 forming glass or glass ceramic.

Glass or glass-ceramic plates are otherwise generally produced by rolling, in the case of a glass ceramic by rolling a green glass plate that is subsequently ceramized. Plate-shaped bodies with flat surfaces are thereby obtained.

FIG. 6 shows a composite material for armoring having two plates placed on one another and made from various inventive composite materials 200 and 201. For example, the composite materials 200 and 201 can respectively exhibit various glass and/or glass-ceramic materials. Alternatively or in addition, the materials can differ with regard to the size and/or composition and/or materials of the embedded particles and/or fibers. The two composite materials can advantageously be fused directly onto one another. To this end, for example, a preliminary body can be produced which exhibits correspondingly different layers, for example layers with different materials forming glass or glass ceramic. This preliminary body can then be converted by liquid phase sintering into the composite material, or here a composite having a number of composite materials. In addition, it is easy to lay at least two individually produced composite materials 200, 201 on one another and hold them by a suitable backing or a substrate.

FIG. 7 illustrates an example of armoring against high dynamic impulsive loads with the aid of the inventive composite material in the form of a bulletproof vest 35.

The textile material 37 of the vest 35 serves as substrate for plates of the composite material 2 that can, for example, be sewn in between two textile plies. The sewed-in plates, not visible from outside, of the composite material are illustrated as dashed lines in FIG. 9. Aramid fabrics or uHDPE (ultra high density polyethylene) fabric, for example, come into consideration as textile substrate material.

It is evident to the person skilled in the art that the invention is not restricted to the above-described exemplary embodiments. In particular, the individual features of the exemplary embodiments can also be combined with one another in a variety of ways.

1. An armoring against high dynamic impulsive loads, comprising a composite material having at least two phases, the first phase forming a matrix for the second phase, and the first phase being a glass or a glass ceramic, and the second phase being embedded and distributed in the form of particles and/or fibers in the matrix formed by the material of the first phase.

2. The armoring as claimed in claim 1, wherein the second phase comprises at least one of the following materials:
carbon fibers,
glass fibers,
fibers with SiC, Si₃N₄, Al₂O₃, ZrO₂, boron nitride, and/or mullite as main components,
steel fibers,
metal particles,
particles with SiC, Si₃N₄, Al₂O₃, ZrO₂, boron nitride, and/or mullite as main components.

3. The armoring as claimed in claim 1, wherein the fibers and/or particles exhibit a varying density and/or composition and/or size in a direction perpendicular to an exposed side of the armoring.

4. The armoring as claimed in claim 1, wherein the armoring is of plate-shaped design, and the fibers or particles are arranged with density varying perpendicular to a lateral surface of the plate-shaped armoring.

5. The armoring as claimed in claim 1, wherein the second phase comprises an at least partially ordered arrangement of nonmetallic fibers, in particular a woven, knitted or nonwoven fabric.

6. The armoring as claimed in claim 1, wherein the first phase comprises a CaO—Al₂O₃—SiO₂ glass ceramic, or MgO—CaO—BaO—Al₂O₃—SiO₂ glass ceramic.

7. The armoring as claimed in claim 1, wherein the first phase comprises an Mg—Al-containing glass ceramic with a spinel phase.

8. The armoring as claimed in claim 1, wherein the first phase comprises a borosilicate glass.

9. The armoring as claimed in claim 1, wherein the first phase comprises an aluminosilicate glass.

10. The armoring as claimed in claim 1, wherein the first phase comprises an alkaline alkaline-earth silicate glass.

11. The armoring as claimed in claim 1, wherein the second phase has a volume fraction in the range from 10 to 70% by volume.

12. The armoring as claimed in claim 1, wherein the composite material exhibits a density of above 99% of the theoretical density of a nonporous body.

13. The armoring as claimed in claim 1, wherein the composite material exhibits a density of below 3.5 g/cm³.

14. The armoring as claimed in claim 1, wherein the second phase comprises particles in the form of metal chips.

15. The armoring as claimed in claim 1, wherein the second phase comprises fibers with diameters of less than 0.2 millimeters.

16. The armoring as claimed in claim 1, wherein at least two different composite materials having a glass or glass-ceramic matrix and fibers and/or particles distributed therein are arranged on one another.

17. A method for producing armoring against high dynamic impulsive loads, the method comprising:
mixing fibers and/or particles with pulverulent material that forms a glass or glass-ceramic matrix, and
heating the mixture such that there is formed from the material that forms a glass or glass-ceramic matrix a flowable glass or glass-ceramic phase that fills in interspaces between the fibers and/or particles such that after being cooled the fibers and/or particles are embedded and distributed in the solidified glass or glass-ceramic phase.

18. The method as claimed in claim 17, wherein the armoring is produced by hot isostatic pressing of the mixture.

19. The method as claimed in claim 17, wherein a preliminary body of the mixture is produced and the preliminary body is subsequently uniaxially hot pressed.

20. The method as claimed in claim 17, wherein a preliminary body is produced from the mixture by cold isostatic pressing, and said preliminary body is subsequently sintered by heating.

21. The method as claimed in claim 17, wherein powder of a starting glass for glass ceramic is used as material that forms a glass matrix or glass-ceramic matrix, and a ceramizing of the starting glass takes place during the heating of the mixture.

22. The method as claimed in claim 17, wherein a borosilicate glass matrix is produced.

23. The method as claimed in claim 17, wherein an aluminosilicate glass matrix is produced.

24. The method as claimed in claim 17, wherein an alkaline alkaline-earth silicate glass matrix is produced.

25. The method as claimed in claim 17, wherein a mixture of the starting materials for a glass or a glass ceramic is used as material that forms a glass or glass-ceramic matrix, and is mixed with the fibers and/or grains.

26. The method as claimed in claim 17, wherein hard particles are mixed with pulverulent material that forms a glass or glass-ceramic matrix.

27. The method as claimed in claim 26, wherein zirconium oxide particles are mixed with pulverulent material that forms a glass or glass-ceramic matrix.

28. The method as claimed in claim 17, wherein glass fibers and/or hard fibers and/or carbon fibers are mixed with the pulverulent material that forms a glass or glass-ceramic matrix.

29. The method as claimed in claim 17, wherein metal fibers and/or particles are mixed with the pulverulent material that forms a glass or glass-ceramic matrix, and the mixture is inductively heated, the metal fibers and/or particles being heated by the electromagnetic field of the induction heating, and outputting the heat to the surrounding material.

30. A method for producing a personal protection device or for armoring vehicles or flying apparatuses, the method comprising utilizing the armoring as claimed in claim 1.
